(19) United States
(12) Patent Application Publication
(10) Pub. No.: US 2014/0027605 A1
(43) Pub. Date: Jan. 30, 2014

(54) Ladder support

(71) Applicant: James T. Chow, Toronto (CA)

(72) Inventor: James T. Chow, Toronto (CA)

(21) Appl. No.: 13/815,366

(22) Filed: Feb. 26, 2013

(30) Foreign Application Priority Data
Feb. 27, 2012 (CA) 2,769,963

(51) Int. Cl. E06C 7/18

(52) U.S. Cl. CPC E06C 7/188
USPC 248/689; 248/682

(57) ABSTRACT

The support for a ladder has a frame which may be attached at various points on a ladder so that when the ladder is standing for use, the elevation of the frame is adjustable. The frame has an outer arm which extends parallel to the transverse axis of the ladder and outwardly from both of its sides. The arm is provided with two or more contacting surfaces which make with the stationary object which supports the ladder.

This Application claims priority pursuant to 35 USC 119 of Canadian application no 2,769,963 filed on Feb. 27, 2012 the entire content of which is hereby incorporated into the following application by reference.

### FIELD OF THE INVENTION

This invention relates to a support for a ladder when standing for use and more particularly to a support which may be attached and detached from a ladder and which has provision for adjustment of its location in order to provide the best support for a ladder.

### BACKGROUND OF THE INVENTION

A ladder which is in a position for use must be firmly supported for reasons of safety. Very often there is no place where the ladder can be placed where it will give access to where it is required while ensuring that it is adequately supported. For example, if a ladder is required to give access to a window in an upper storey of a building, the window may be adjacent to the corner of the building, it may be adjacent to a downspout or it may be wider than the width of the ladder itself. In these situations, it may be impossible to place the ladder to safely reach the window.

If a ladder is required to give access to the soffit or fascia of a building or to a roof, the only support available is usually the gutter attached to the eaves of the building. Gutters are not intended for such use and rarely are strong enough to provide proper support for a ladder. Likewise, vinyl siding on a building is rarely strong enough to support a ladder and if a ladder is placed against it, the vinyl usually is dented by the weight of the ladder and becomes unsightly.

### SUMMARY OF THE INVENTION

I have invented a support for a ladder which can be placed where it will provide best support for the ladder. Briefly, the support of my invention includes a frame removably attachable to a ladder at preselected locations thereon such that when a ladder is standing for use; the elevation of the frame is adjustable. The frame is provided with contacting surfaces which are adapted to contact a stationary object for supporting the ladder.

### DESCRIPTION OF THE DRAWINGS

The ladder support of my invention is described with reference to the accompanying drawings:

FIGS. 1 and 2 are perspective views of the ladder support in conjunction with a conventional ladder;

FIG. 3 is a perspective view of a rung connector of the ladder support;

FIG. 4 is an elevation of the rung connector;

FIG. 5 is a perspective view of a link of the ladder support; and

FIGS. 6 and 7 are further perspective views of the ladder support.

Like reference characters refer to like parts throughout the description of the ladder support.

### DESCRIPTION OF PREFERRED EMBODIMENT

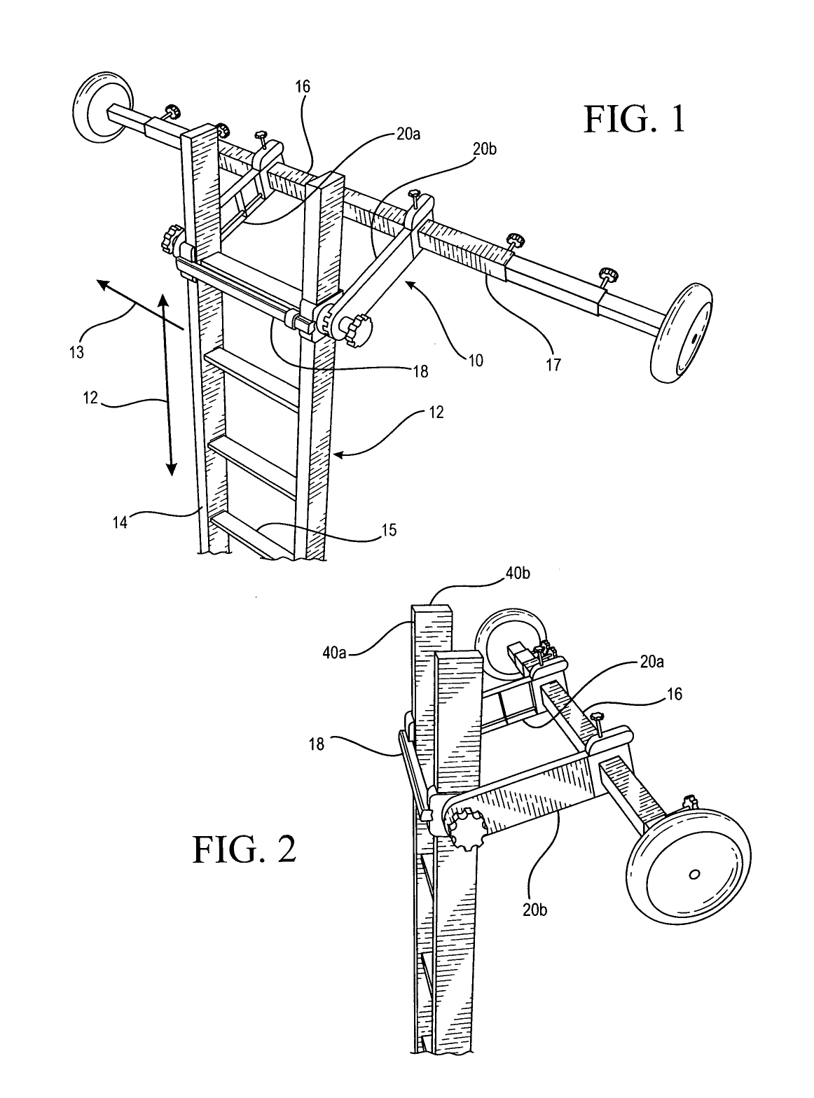

With reference to FIGS. 1 and 2, the ladder support of the invention, generally 10, is shown in conjunction with a conventional ladder 12. The ladder has longitudinal and transverse axes 12,13 respectively. A pair of vertical supports 14 run parallel to the longitudinal axis and rungs 15 run parallel to the transverse axis.

The ladder support includes a frame, generally 16 having an outer arm 17, a rung connector, generally 18 and a pair of links 20a,b which interconnect the outer arm and the rung connector

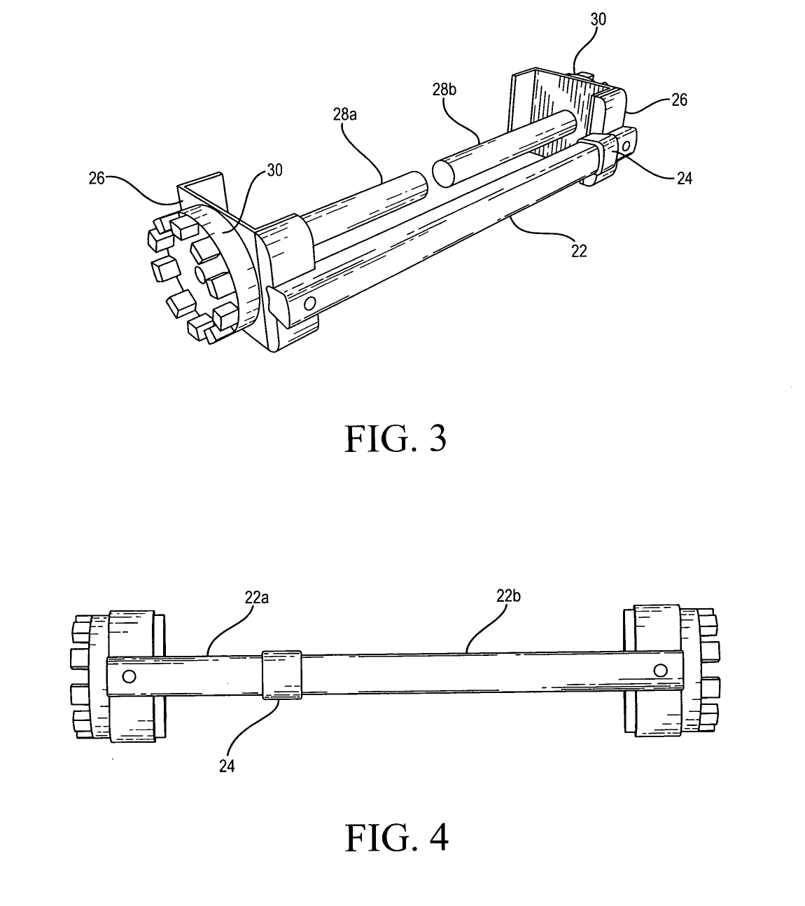

With reference to FIGS. 3 and 4, the rung connector 18 includes an outer tube 22 which is composed of a pair of sections 22a,b movable longitudinally of each other in telescopic relationship to define a variable effective length. A conventional locking ring 24 when tightened prevents the sections from moving relative to each other. The outer tube and locking ring function as clamping means for the rung connector as is explained below.

On each side of the rung connector is a U-shaped end wall 26 to which the outer ends of the outer tube are welded or otherwise attached. An inner tube 28 extends inwardly from each end wall and like the outer tube 22, the inner tube is composed of two segments 28a,b in telescopic relationship with each other. A circular toothed coupling 30 is welded or otherwise attached to the outer wall of each end wall and its function is described below.

Preferably, the end walls 26 are constructed so that they can be fastened firmly to the vertical supports of a conventional ladder intended for industrial use. The vertical supports of the ladder are generally channels and the rungs are tubular. Such a ladder is illustrated in FIGS. 1 and 2. In those illustrations, flanges 40a extend inwardly from outer webs 40b of the vertical supports. The webs generally are about 3 inches in width and the rungs are spaced apart about 1 foot.

The flanges 26a of end walls 26 are spaced apart slightly more than 3 inches so that the end walls fit snugly over the vertical supports of the ladder. The segments of the inner tube 28 are arranged so that they fit into the hollows of the rungs of the ladder when the end walls fit over the vertical supports of the ladder.

The end walls 26 are clamped or affixed to the rung of a ladder by means of outer tube 22. As the end walls of the rung connector are pushed toward each in order to fit them over separate vertical supports of the ladder, the two segments of the outer tube slide toward each other. When no further inward movement is possible, the segments are immobilized by means of locking pin 24. The end walls of the rung connector are then locked into engagement with the ladder.

The outer tube and locking pin accordingly function to clamp the rung connector to the ladder. Since the inner tube can be inserted into any of the rungs of the ladder, the elevation of the rung connector is adjustable. The ladder support is accordingly adjustable on the ladder at preselected locations thereon i.e. wherever this is a rung.

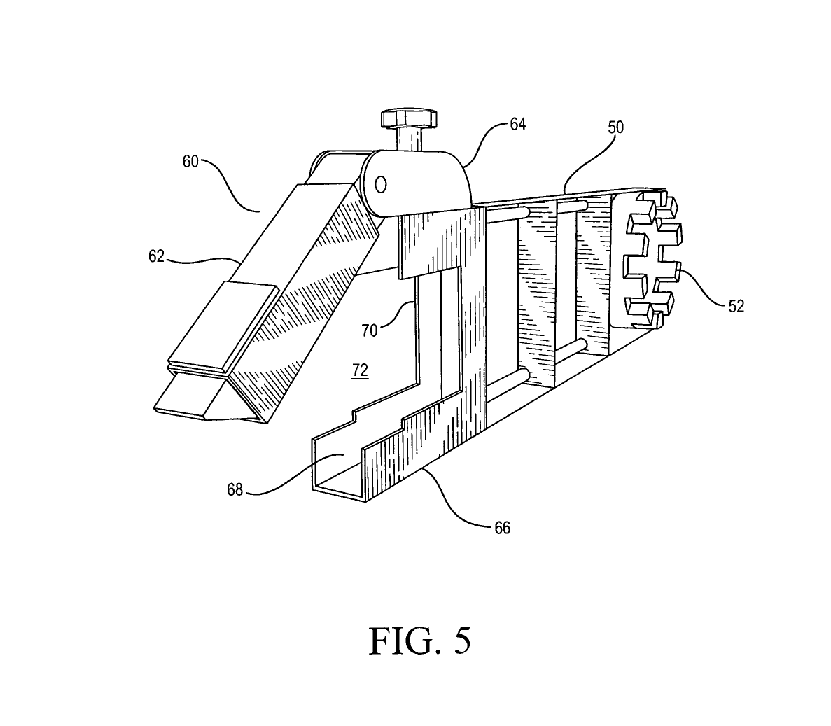

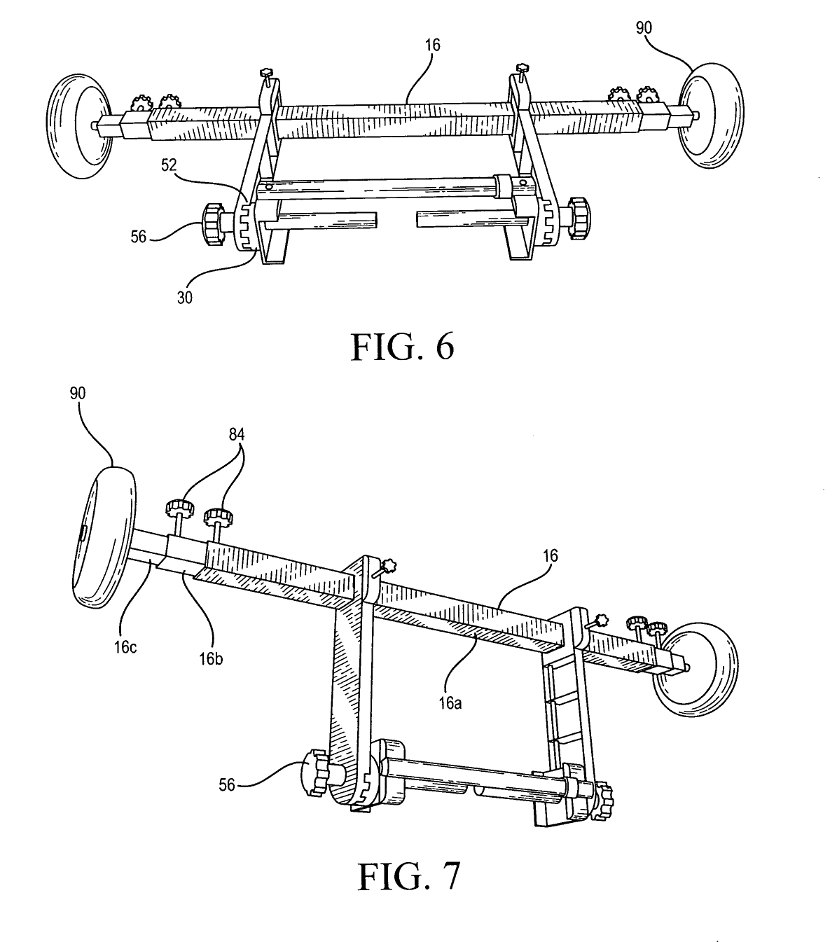

With reference to FIGS. 5, 6 and 7, each link 20 is composed of a channel 50 to which a circular toothed coupling 52 is welded or otherwise attached to its inner end. The teeth of the coupling and the spaces between them mate with the teeth and spaces of each of the couplings 30 of the rung connector. The two couplings 52, 30 are outer and inner of each other. respectively, and are interconnected by a bolt (not illustrated) which extends through the end walls 26 of the rung connector, through the two couplings 30, 52 and terminates at a threaded outer end to which a knurled knob 56 is threadably attached.

Loosening of knob 56 allows the links which are slidable on outer arm 16 to be separated from the rung connector so that the inner coupling 30 can be rotated relative to the outer coupling 52 with resulting alteration of the angle of the ladder relative to the links. The angle of the outer arm 16 can accordingly be altered relative to the ladder.

A fastener, generally 60, interconnects the outer ends of the links and the outer arm 16 of the frame. The fastener consists of an limb 62 which is mounted to a hollow mount 64 secured to the top flange of the channel of the link. The bottom of the limb is removably received in an upwardly opening trough 66. A removable pin 68 locks the limb in the trough

Fastener 60 and the end outer edge 70 of the channel define a rectangular opening 72 for receipt of a rectangular hollow central tube 16a of the outer arm of the frame. Extending from each end of the central tube is a second rectangular tube 16b which has a smaller cross-section than the central tube and which, accordingly, is slidable in the hollow interior of the central tube. A third rectangular tube 16c fits into each end of second tubes. The tubes but may be immobilized by means of a number of thumb screws 84 spaced along the length of the arm. The effective length of the outer arm is accordingly variable because of the telescopic relationship of its components.

A wheel 90 is mounted for rotation to the outer end of each third tube 16c. Each wheel is horizontally spaced apart from the ladder and its circular outer wall constitute a contacting surface which is adapted to contact a stationary object which supports the ladder. The stationary object will normally be the wall of a building but other objects may provide the necessary support. The wheels thus prevent the ladder from touching the wall or other stationary object when the ladder is standing for use.

By means of the thus-described ladder support, the position of wheels 90 can be positioned where they will provide best support for the ladder. The angle of links can be adjusted by means of couplings 30, 52 thereby permitting vertical adjustment of the wheels while the telescopic structure of the outer arm 16 permits horizontal adjustment of the wheels.

It will be understood, of course, that modification can be made to the structure of the ladder support of the invention without departing from the scope and purview of the invention as defined in the appended claims.

I claim:

1. A ladder support for supporting a ladder when standing for use adjacent to a stationary object, said ladder support including: a frame removably attachable to said ladder at preselected locations thereon such that when said ladder is standing for use, the elevation of said frame is adjustable; and contacting surfaces provided on said frame, said contacting surfaces being adapted to contact said stationary object for supporting said ladder.

2. The ladder support of claim 1 wherein said frame includes an arm which extends outwardly from said frame and on which said contacting surfaces are located.

3. The ladder support of claim 1 wherein said frame has an elongated arm on which said contacting surfaces are located, said arm, when said frame is attached to said ladder and when said ladder is standing for use, being adapted to be spaced apart along its length from said stationary object save and except for said contacting surfaces.

4. The ladder support of claim 1 wherein said frame has an elongated arm on which a pair of said contacting surfaces are located, said arm, when said frame is attached to said ladder and when said ladder is standing for use, being adapted to be spaced apart along its length from said stationary object save and except for said contacting surfaces, said arm further being adapted to extend along a transverse axis of said ladder which has both longitudinal and transverse axes and a pair of vertical supports which run parallel to said longitudinal axis, said arm still further being adapted to extend outwardly from opposite sides of said vertical supports, said pair of said contacting surfaces being located on opposite sides of said ladder.

5. The ladder support of claim 4 wherein said arm is telescopic such that its effective length is adjustable with resulting adjustability of the location of said contacting surfaces on said stationary object.

6. The ladder support of claim 1 wherein said contacting surfaces are located on said frame such that said contacting surfaces are the only contact which said frame and said ladder make with said stationary object when said frame is attached to said ladder and when said ladder is standing for use.

7. The ladder support of claim 6 wherein said contacting surfaces are composed of material which minimizes damage to said stationary object when in contact therewith.

8. The ladder support of claim 3 further including a pair of wheels mounted for rotation to said arm and each having a circular outer wall, each said contacting surface being defined by a separate said outer wall.

9. The ladder support of claim 1 wherein said frame is provided with a pair of end walls for removably attaching said frame to said ladder, each said end wall having a separate segment of an inner tube, said inner tube segments being in telescopic relationship with each other and being adapted to extend into a hollow rung of said ladder; and clamping means for clamping said end walls to said separate vertical supports such that each said end wall is clamped to a separate vertical support of said ladder at opposite ends of said rung.

10. The ladder support of claim 9 wherein said clamping means includes an outer tube spaced apart from said ladder when said frame is attached to said ladder, said outer tube being composed of a pair of segments in telescopic relationship with each other, each said segment of said outer tube being movable with a separate said end wall such that movement of said outer walls toward each other results in a shortening of the effective length of said outer tube; and a locking ring for selectively preventing telescopic movement of said segments of said outer tube.
